(19) United States
(12) Patent Application Publication
(10) Pub. No.: US 2010/0192362 A1
(43) Pub. Date: Aug. 5, 2010

(54) Split Charge Forming Process for Battery

(75) Inventors: Sang-Young YOON, Lexington, MA (US); Rocco IOCCO, Beverly, MA (US)

Correspondence Address: WILMERHALE/DC, 1875 PENNSYLVANIA AVE., NW, WASHINGTON, DC, 20006, US

(73) Assignee: A123 System, Inc., Watertown, MA (US)

(21) Appl. No.: 12/558,091

(22) Filed: Sep. 11, 2009

Related U.S. Application Data
(60) Provisional application No. 61/096,202, filed on Sep. 11, 2008.

(51) Int. Cl. H01M 6/00

(52) U.S. Cl. 29/623.2; 29/623.1

(57) ABSTRACT

A split formation method of forming an electrochemical cell includes providing the electrochemical chemical cell with an electrolyte for activation of the cell. A wait period is then conducted without a charge being applied. Thereafter, the cell is initially charged to an amount falling into a predetermined state of charge (SOC) range. After the charge is applied, the cell is stored for an extended period of time in a controlled temperature environment. A degassing procedure may be performed after storage to provide a uniform distance between the electrodes. Upon completion of the storage period a further charge is applied to cell that is higher than the initial charge. The cell is then allowed to stabilize for a predetermined amount of time at a set temperature.

### CROSS-REFERENCE

This application claims the benefit under 35 U.S.C. §119(e) of U.S. Provisional Patent Application No. 61/096,202, filed on Sep. 11, 2008, entitled Split Charge Forming Process for Battery, which is herein incorporated by reference in its entirety.

### FIELD OF THE INVENTION

Exemplary embodiments consistent with the present invention generally relate to electrochemical cells, and more particularly, to a split formation process for electrochemical cells.

### BACKGROUND

Electrochemical cell shapes are generally classified as either prismatic or cylindrical. Cylindrical cells have cylindrical housings. Common examples of cylindrical batteries are standard alkaline sizes AA, AAA, C and D. Prismatic cells have prismatic housing shapes, such as parallelepipeds. Common examples of prismatic cells include standard 12 V car batteries. An electrochemical cell can be, for example, a lithium ion cell. The chemical reaction in a lithium ion battery allows for the lithium in a positive electrode lithium material to be ionized during charge, and move from layer to layer in a negative electrode.

A prismatic cell can be constructed by stacking positive and negative electrode sheets together. Anode sheets and cathode sheets are separated by electrically insulating separator sheets. The stacked sheets can be further rolled up, which may be referred to as stack winding, or folded back and forth, which may be referred to as zig-zag folding. A combination of these two approaches may also be used. A prismatic cell can also be made by winding the electrodes around a flat mandrel, creating a “wound, flat wrap” design.

A conventional method for forming an electrochemical cell is illustrated in FIG. 1. The cell is activated by providing an electrolyte in a traditional manner (S10). When the electrode sheets of the cell come into contact with electrolyte, the coated electrodes enable an electrochemical reaction within the cell so that electricity is stored or produced in the cell. After the electrolyte is added, the cell is charged to a predetermined cell capacity to more than 50%, and typically between 90%-100% (S12). The cell is then permitted to stabilize for a predetermined amount of time (S14). During the forming process, a solid-electrolyte interface (SEI) is formed on the electrode surfaces of lithium-ion batteries. The SEI film is due to electrochemical reduction of elements in the electrolyte. The presence of the SEI film plays an important role in the battery performance. Uniform electrolyte wetting and stable SEI formation provides better cycle life and high temperature storage performance. Traditional formation processes often result in a loss of capacity, deteriorated cycles, and poor storage performance due to a non-uniform and/or incomplete reaction of particles and unstable SEI film on graphite anode surfaces.

Small particles or powders are used in the fabrication process of anodes and cathodes for high power applications. In turn, the small particles form small porous channels during fabrication, which make electrolyte wetting difficult, degrading performance and detrimentally affecting dc resistance.

### SUMMARY OF THE NON-LIMITING EMBODIMENTS OF THE INVENTION

Exemplary embodiments of the present invention provide a method of forming an electrode chemical cell including providing the cell with an electrolyte for activation. A wait period is then conducted without a charge being applied. Thereafter, the cell is initially charged to an amount falling into a predetermined cell capacity. After the charge is applied, the cell is stored for an extended period of time in a controlled temperature environment. A degassing procedure may be performed after storage to provide a uniform distance between the electrodes. Upon completion of the storage period, a further charge is applied to the cell that is higher than the initial charge. The cell is then allowed to stabilize for a predetermined amount of time at a set temperature.

In accordance with an exemplary aspect of the invention, the initial wait period comprises substantially a 24 hour period. The initial charge may comprise a C/100-C/2 charge, or more particularly, a C/20 charge for two hours, followed by a C/5 charge to 20% of cell capacity, for example. After the desired charging capacity is obtained, the cell is stored for an extended period of time at a controlled temperature. In an exemplary embodiment, the storage period is two days at 45 degrees Celsius, followed by a period of one day at room temperature, e.g., 23 degrees Celsius.

After completion of the storage period, the subsequent charge includes applying a charge substantially between 80%-100% of cell capacity. The final stabilization process may encompass a period of storing for one to seven days at room temperature, −60 degrees Celsius, or more particularly, three days at 45 degrees Celsius.

In accordance with an exemplary aspect of the invention, the anode may be a blend of natural graphite, synthetic graphite and styrene-butadiene rubber (SBR). Alternatively, the anode may be a blend of synthetic graphite and polyvinylidene fluoride (PVDF). The anode may include at least one of natural graphite, synthetic graphite, and a blend of natural graphite and synthetic graphite, natural graphite mixture, synthetic graphite mixture with styrene-butadiene rubber, metal compounds, hard carbon, and their all blends as well as graphite powder.

### BRIEF DESCRIPTION OF THE DRAWINGS

Exemplary embodiments of the invention are described with reference to the following figures, which are provided for the purpose of illustration only.

FIG. 1 is a diagram illustrating a traditional process for forming an electrochemical cell;

FIG. 2 is a diagram illustrating a process for forming an electrochemical cell according to an exemplary embodiment of the present invention; and

FIG. 3 is a graph representing a prior method of forming an electrochemical cell verses a formation method according to an exemplary embodiment of the present invention.

### DETAILED DESCRIPTION OF NON-LIMITING EMBODIMENTS OF THE INVENTION

Embodiments of the present invention provide an apparatus and method of producing an electrode chemical cell. The electrochemical cell is formed through an iterative charge process comprising different charge operations separated by storing of the cell. The finalized electrochemical cell provides higher energy density, and increased storage performance.

An exemplary aspect of the invention is to obtain an electrochemical cell, such as high power or high energy density lithium ion, with high capacity and increased life span by applying a unique split formation process. In accordance with an exemplary embodiment of the invention, the electrochemical cell is initially activated in a traditional manner by providing the electrochemical cell with an electrolyte.

Thereafter, a series of charging operations are performed that are separated by a waiting period. For example, a precharge of around 10-30% of cell capacity is provided that creates SEI on the anode particle surface of the cell. The precharge may be applied while the cell is in an unsealed state. The cell is then keep at a high designated temperature for several days to provide a state of charge (SOC) equilibrium and to form a uniform SEI film for graphite pieces of the anode. It is noted that the respective graphite powder may be highly graphitized in the shape of an irregular shape particle, boulder, plate or flake shape.

During the precharging stage as described above, gas may build up within the electrochemical cell. In an exemplary embodiment, the precharge is conducted to the electrochemical cell in the unsealed state, such that generated gas is removed through an opening in the cell. The cell is then appropriately sealed and prepared for a storage period.

Storage is conducted at a designated temperature, such that the graphite particles of the anode beneficially advance toward having a uniform SEI film and state of charge. The graphite particles will also be wetted by the electrolyte due to an equilibrium condition achieved by the storage. As the electrolyte wetting process advances, uniform wetting is provided throughout the anode. Uniform wetting may be furthered after storage due to generated gas moving out between positive and negative electrodes. Improving the wetting uniformity obtained during the storage period increases the contact area between the electrode and the electrolyte and affects cell capacity, in addition to improving low temperature discharging operations.

Electrolyte wetting is more difficult when small sized powders or particles are used to form the electrode. This is because the small sized particles result in the creation of fine channels. This is particularly an issue for anode electrode, as they often comprise particles that have a smaller size than cathode electrodes. Processes in accordance with exemplary embodiments of the invention provide for more uniform wetting, resulting in lower impedance and direct current resistance. The uniformity provided by the operations of splitting the charging steps and using an intermediate storage step results in improved cycling and high temperature storage performance. Degassing may be performed during or after storage to assist in providing a uniform distance between the electrodes and to further assist with the wetting process.

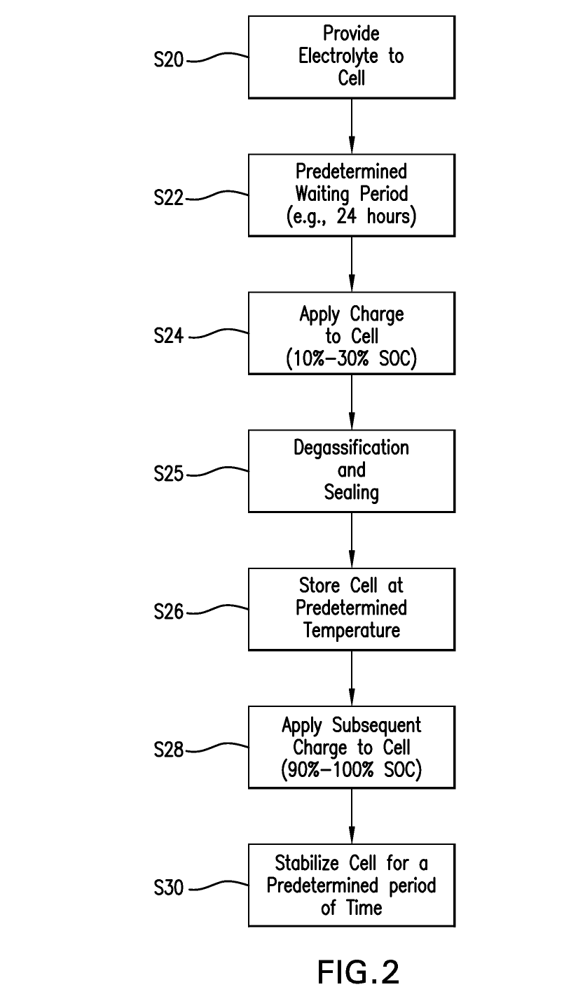

FIG. 2 represents a process of forming an electrochemical cell according to an exemplary embodiment of the invention. As shown in FIG. 2, the electrochemical cell is provided with an electrolyte in a known manner (S20). A wait period, e.g., 24 hours, is carried out after the electrolyte is applied (S22). The waiting period may be conducted in a controlled environment, if desired, but is not necessarily required. The cell is then initially charged at a rate of, for example, C/20 charge for two hours, followed by a C/5 charge to obtain a 10%-30% of cell capacity, and preferably, but not necessarily, a 20% SOC, less than 50% (S24). After the desired SOC is obtained, the cell is stored for an extended period of time and at a controlled temperature (S26). In an exemplary embodiment, the storage period is two days at 45 degrees Celsius, followed by a period of a few hours to one day at room temperature, e.g., 23 degrees Celsius. A degassing and sealing procedure may be performed if applicable after the initial charge or after storage to provide a uniform distance between the electrodes (S25). The degassing is conducted through a hole in the electrochemical cell and the hole is thereafter closed to seal the cell. The formation process then includes charging the cell to a 90%-100% SOC (S28) and subsequently stabilizing the cell for a time period of, for example, several days at 45 degrees Celsius (S30).

An anode according to the present invention may be a blend of natural graphite, synthetic graphite and styrene-butadiene rubber. Alternatively, the anode may have a blend of synthetic graphite and polyvinylidene fluoride. The invention is not limited to these electrodes and the present technique can be applied to general lithium ion cells. Electrochemical cells formed according to an embodiment of the present invention may accommodate high power cells, which incorporate electrodes formed from small particles of less than 15 μm. For example, the particles have a diameter or effective diameter of less than 15 μm. Such small particles further the creation of detrimentally small channels in the electrode that are traditionally difficult to wet.

Table 1 below shows the direct current resistance of cell groups formed according to an exemplary embodiment of the present invention and contrasted with cells provided by a traditional formation. One group includes graphite with the SBR binder, and the other group includes graphite binder with PVDF binder.

TABLE 1

| Description | Formation | DCR |
|---|---|---|
| Graphite Anode w/ SBR | Traditional | 100% |
| Binder | Split Formation | 78% |
| Graphite Anode w/ PVDF | Traditional | 100% |
| Binder | Split Formation | 70% |

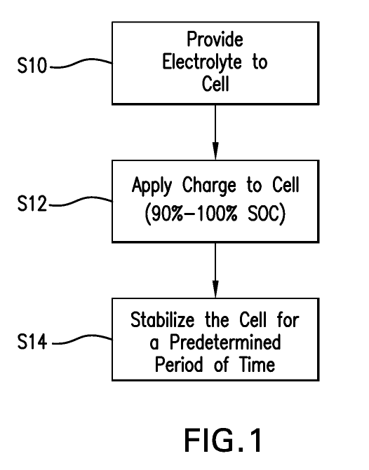

As shown in Table 1, the groups that underwent split formation show lower DCR impedance immediately after formation. The DCR value is used as a gauge for determining wetness of the electrodes. Although a graphite anode with SBR binder is typically not easily wetted by Li-ion mixed-carbonate electrolytes, the iterative formation process of embodiments of the present invention cause the DCR to be lowered, providing advantages over prior methods of cell formation. Cells from each group in Table 1 were disassembled prior to the final stabilization (e.g., after S10 in FIG. 1; and after S26 in FIG. 2) and visual inspection of the electrodes confirmed that the method of charging and storing according to an embodiment of the present invention promotes beneficial wettability of the electrodes.

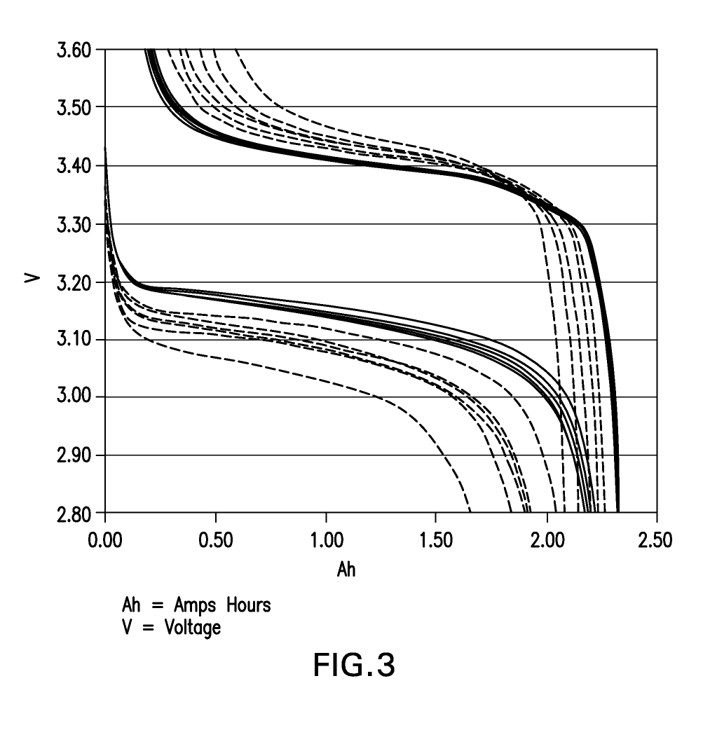

FIG. 3 is a graph illustrating cell test results charting voltage verses Amp hours (Ah) over charge and discharge cycles. The solid lines represent electrochemical cells that were formed using split formation methods in accordance with an embodiment of the present invention, while the dotted lines represent cells formed using the prior art standard formation procedure of FIG. 1. As shown, superior results are produced by the present invention in the form of uniform reactions and improved capacity. The polarization curves of these groups also show a tendency for the anode of the prior art to plate lithium during charging, which was not apparent in the group that utilized the split-formation technique of the present invention.

As shown below, Table 2 demonstrates cycling data of electrochemical cell groups formed according to an embodiment of the present invention in comparison to a traditional configuration. The cycle performance data was taken of an anode comprised of graphite with a PVDF binder. The anode was subjected to a 3 amp charge and 20 amp discharge.

| | | Cycle performance |
|---|---|---|
| | | (capacity retention |
| Description | Formation | at 600 cycle) |
| Graphite anode | Traditional | 83% |
| with PVDF binder | Split | 92% |
| | formation | |

The cell groups subjected to the split formation charge according to an embodiment of the present invention demonstrate a significantly improved capacity retention rate after 600 cycles. Due to the iterative formation process of the present invention, as described above, the cycle performance is improved from 83% to 92%. Improved cycle performance of the cell group is due to aspects of the present invention, including providing uniform and complete electrolyte wetting and stable formation of the SEI film. It is noted that the above storage periods, temperatures, SOC percentages, iterations and the like are given as examples and although particular exemplary embodiments of the invention have been described in detail for purposes of illustration, various modifications and enhancements may be made without departing from the spirit and scope of the invention. Numerous additional advantages or modifications may be realized by those having ordinary skill in the art. Accordingly, it is intended that the invention not be limited to the disclosed exemplary embodiments.

1. A method of forming an electrode chemical cell, the method comprising:
providing an electrochemical chemical cell with an electrolyte, the electrochemical cell including electrodes;
applying an initial charge to the electrochemical cell;
storing the electrochemical cell to provide uniform electrode wetting of at least one of the electrodes, the at least one electrode being formed of particles having a size less than 15 μm;
applying a second charge to the electrochemical cell greater than the initial charge; and
stabilizing the electrochemical cell for a predetermined amount of time.

2. The method of claim 1, wherein the initial charge comprises less than 50% of cell capacity.

3. The method of claim 2, wherein the initial charge comprises between 10-30% of the cell's capacity.

4. The method of claim 1, wherein the initial charge comprises a C/100-C/2 charge for two hours to 20% of the cell's capacity

5. The method of claim 1, wherein the second charge includes applying a charge substantially between 80%-100% of the cell's capacity.

6. The method of claim 1, wherein the stabilizing comprises substantially a few hours to less than seven days.

7. The method of claim 1, wherein the electrochemical cell is degassed and sealed before applying the second charge.

8. The method of claim 1, wherein the electrodes comprise an anode with at least one of natural graphite, synthetic graphite, and a blend of natural graphite and synthetic graphite, natural graphite mixture, synthetic graphite mixture with styrene-butadiene rubber.

9. The method of claim 1, wherein the electrodes comprise an anode with at least one of natural graphite, synthetic graphite, a blend of natural graphite and synthetic graphite, natural graphite mixture, and synthetic graphite mixtures with polyvinylidene fluoride.

10. A method of forming an electrode chemical cell, the method comprising:
providing an electrochemical chemical cell with an electrolyte, the electrochemical cell having electrodes formed from particles that are less than 15 μm;
placing the electrochemical cell in a waiting state for a predetermined amount of time in an unsealed condition;
applying a split charge to the electrochemical cell, the split charge comprising at least first and second charging operations separated by a storage period, the second charging operation resulting in the cell having a greater state of charge than the first charging period; and
sealing the electrochemical cell before the second charging operation.

11. The method of claim 10, wherein the first charging operation comprises less than 50% of the cell's capacity.

12. The method of claim 10, wherein the split charge comprises a C/100-C/2 charge for two hours to 20% of the cell's capacity

13. The method of claim 10, wherein the second charging operation includes applying a charge substantially between 80%-100% of the cell's capacity.

14. The method of claim 10, further including conducting a stabilization process after the second charging operation for a period of substantially one to seven days at a predetermined temperature.

15. The method of claim 10, wherein the electrodes comprise an anode made of at least one of natural graphite, synthetic graphite, and a blend of natural graphite and synthetic graphite, natural graphite mixture, synthetic graphite mixture with styrene-butadiene rubber.

16. The method of claim 10, wherein the electrodes comprise an anode made of at least one of natural graphite, synthetic graphite, a blend of natural graphite and synthetic graphite, natural graphite mixture, and synthetic graphite mixtures with polyvinylidene fluoride.

17. The method of claim 10, wherein after the first charging operation, the electrochemical cell is degassed to provide a uniform distance between the electrodes.
